(19) United States
(12) Patent Application Publication
(10) Pub. No.: US 2026/0111312 A1
(43) Pub. Date: Apr. 23, 2026

(54) Erasure Coding With Multiple Fragments On A Single Node

(71) Applicant: NetApp, Inc., San Jose, CA (US)

(72) Inventors: Nikhil Narahari Kamat, Vancouver, BC (CA); Joon Hur, Creve Coeur, MO (US); Michal Jakub Dacko, Vancouver, BC (CA)

(73) Assignee: NetApp, Inc., San Jose, CA (US)

(21) Appl. No.: 18/923,792

(22) Filed: Oct. 23, 2024

(51) Int. Cl. G06F 11/10

(52) U.S. Cl. CPC G06F 11/1076; G06F 11/1048

(57) ABSTRACT

Techniques for efficiently and durably implementing erasure coding. Data objects are processed to extract metadata, which is used to identify fragments of the data object and the stripe to which the fragments belong. The techniques described herein evaluate failure domains at the drive-level rather than at the node-level, thereby greatly expanding the number of failure domains for fragment storage. To support object availability and durability, each drive-level failure may only hold one fragment from any given stripe. Further, the storage drives of each storage node are restricted such that the total number of fragments from any given stripe stored in the storage node does not exceed a limit. With this arrangement, not only can erasure coding can be implemented while using fewer computing resources when compared with node-level failure domains, but data objects can also be reconstructed without compromising data integrity under configurable levels of tolerance to unavailable fragments.

### TECHNICAL FIELD

Aspects of the disclosure are related to the field of computer software applications and, in particular, to the field of data storage.

### BACKGROUND

In data storage systems, object-storage platforms use erasure coding techniques to store data as highly durable objects. Erasure coding stores data objects by splitting them into fragments. The fragments are stored in the data storage system and can be used to reconstruct the data object as needed. To store the various fragments of the data object, the fragments are distributed to and stored in failure domains of the data storage system. To support high levels of data availability and durability for the erasure coded data object, fragments are organized into fragment groups (also called “stripes”). For each fragment group, a parity fragment is produced.

Parity fragments contain redundant information allowing a data object to be reconstructed without comprising data integrity in a scenario where some number of fragments are lost. Where any one fragment of a fragment group is lost, the data for the missing fragment can be accurately reproduced using the information in the group's parity fragment and the other surviving fragments. By restricting each failure domain to holding at most one fragment from each fragment group, a domain failure results in the loss of at most one fragment from any given group. Distributing the effects of domain failure across each of the fragment groups mitigates the extent of data loss when a failure domain experiences some problem. As a result, the data of each fragment group can still faithfully be reproduced in spite of losing some number of fragments, and the object can be served.

Beneficially, erasure coding strategies can be configured to tolerate the loss of multiple fragments from any given fragment group while remaining able to reconstruct the erasure coded data object. The maximum number of lost fragments an erasure coding strategy tolerates turns on the number of parity fragments produced for each fragment group. The more parity fragments per fragment group, the more instances of domain failure the data storage system can withstand while still making an erasure coded data object available without compromising the integrity of its data.

In distributed data storage environments, each fragment is placed on a storage node to store the erasure coded object. To satisfy the one-fragment-per-failure-domain standard, the data storage system needs as many storage nodes as there are fragments in each fragment group. For medium and small sized data storage systems, this requirement is an obstacle to efficient erasure coding. One strategy for implementing erasure coding on distributed data storage systems with relatively few storage nodes is to reduce the number of parity fragments in each fragment group. A further strategy is to utilize larger fragments (i.e., dividing the data object into fewer fragments that each container a greater amount of data instead of a larger number of smaller fragments). Unfortunately, while both of these techniques effectively reduce erasure coding overhead by reducing the number of storage nodes needed, they also effectively reduce the number of lost fragments the data storage system can tolerate while continuing to serve an uncompromised reconstructions of data objects.

As such, improvements for efficiently and durably implementing erasure coding strategies on a broader range of data storage system are needed.

### SUMMARY

Disclosed herein are methods and systems for efficiently and durably implementing improved erasure coding. To provide enhanced erasure coding, the disclosed techniques consider failure domains at the storage drive, or some other constituent storage media of the storage node, level. Instead of regarding each storage node of a distributed data storage system as a failure domain, each storage drive, disk, or other storage media within each of the storage nodes is regarded as a failure domain. Each storage node in a distributed data storage system includes multiple storage drives or other storage media, meaning that each storage node may now accept the placement of multiple fragments from a single fragment group. Hereinafter, the various storage media that may be within a given storage node are generally referred to as storage drives for simplicity but may be implemented as various forms of storage media. Drive-aware conflict management allows for the use of wider erasure coding placement strategies (i.e., erasure coding where fragments are on a high number of failure domains) to be implemented in data storage systems having fewer resources. To preserve the durability and availability of data objects, fragments cannot be placed on any storage drive that already contains a fragment from the same fragment group or stripe. Hereinafter, a fragment group is referred to as a stripe.

The fragments of each stripe are distributed to the storage drives of a storage node in accordance with a one-fragment-per-failure-domain standard up until the number of fragments from a given stripe present in the storage node satisfies a predetermined threshold. The predetermined threshold is determined such that, in the case of the entire storage node failing, the fragments lost to that failure are not so numerous as to impede an uncompromised reconstruction of the data object from the fragments that remain available. Where the number of fragments of a particular stripe that are present in a storage node meets or exceeds the predetermined threshold, the storage node is skipped with regard to storing an additional fragment. Metadata for the stripe is updated to indicate that the storage node is at capacity with regard to the stripe, and another storage node is then evaluated for fragment placement.

This Summary introduces a selection of concepts in a simplified form that are further described below. It may be understood that this Summary is not intended to identify key features or essential features of the claimed subject matter, nor is it intended to be used to limit the scope of the claimed subject matter.

### BRIEF DESCRIPTIONS OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operating environment in accordance with an implementation.

FIG. 2 illustrates a method in accordance with an implementation.

FIG. 3 illustrates an operational scenario in accordance with an implementation.

FIG. 4A illustrates a detailed storage service in accordance with an implementation.

FIG. 4B illustrates detailed storage nodes in accordance with an implementation.

FIG. 4C illustrates another operational scenario in accordance with an implementation.

FIG. 5 illustrates an operational sequence in accordance with an implementation.

FIG. 6 illustrates another operational sequence in accordance with an implementation.

FIG. 7A illustrates another method in accordance with an implementation.

FIG. 7B illustrates another method in accordance with an implementation.

FIG. 8 illustrates a computing device in an implementation.

### DETAILED DESCRIPTION

Disclosed herein are methods and systems for efficiently and durably implementing improved erasure coding. To provide enhanced erasure coding the disclosed techniques consider failure domains at the storage drive level. Instead of regarding each storage node of a distributed data storage system as a failure domain, each individual storage drive within each storage node is regarded as a failure domain. A conflict manager on each storage node prohibits placing a fragment on any storage drive that already contains a fragment from the same fragment group or stripe. The fragments of each stripe are distributed to the storage drives of a storage node up until the number of fragments from a given stripe present in the storage node satisfies a predetermined threshold. The predetermined threshold is determined such that, in the case of the entire storage node failing, the fragments lost to that failure are not so numerous as to impede an uncompromised reconstruction of the data object from the surviving fragments.

In implementing the enhanced erasure coding strategies, data objects are processed to extract object metadata. Using the object metadata, fragments of the data object and the stripe to which the fragments belong are identified. The storage node having processed the data object then produces a fragment mapping that determines how to distribute each fragment of the stripe across different storage drives of the data storage system. In some embodiments, a controller of the storage node processes the data object and identifies fragments of the data object that correspond to a given erasure coding stripe. The controller selects a first storage drive from within the same storage node as the controller and places the fragment. Having just processed the data object, the controller can be certain that no fragment from the same erasure coding stripe was previously placed on the selected storage drive. Once the fragment is placed, the controller increments the storage drive selection and places the next fragment. This continues until each fragment of the erasure coding stripe has been placed on a storage drive. By incrementing storage drives with each placement, the controller assures that no fragment is placed onto a storage drive that contains another fragment from the same erasure coding stripe. In some such embodiments, the controller may recognize that the number of fragments to be placed either exceeds the number of storage drives in the storage node, or else the number of fragments to be placed exceeds the storage node's capacity for holding fragments from the erasure coding stripe. In either such case, the controller transmits the fragments that the storage node cannot accommodate to one or more other storage nodes of the distributed data storage system. The storage node that receives the remaining un-stored fragments then determines how the fragments should be placed in a similar manner to the first storage node, and subsequently places the fragments accordingly.

In some embodiments, the controller maintains a mapping of which storage drives have already been used for placing fragments of a particular stripe. By leveraging this mapping, the controller can select storage drives that have not yet been used for placing a fragment of the stripe. The controller places the fragment in the selected storage drive, and then again references the mapping to select the next storage drive for placing the next fragment. This continues until each fragment of the erasure coding stripe has been placed on a storage drive. In some such embodiments, the controller may recognize that the number of fragments to be placed either exceeds the number of storage drives in the storage node, or else the number of fragments to be placed exceeds the storage node's capacity for holding fragments from the erasure coding stripe. In either such case, the controller transmits the fragments that the storage node cannot accommodate to one or more other storage nodes of the distributed data storage system. The storage node that receives the remaining un-stored fragments then determines how the fragments should be placed in a similar manner to the first storage node, and subsequently places the fragments accordingly.

In some embodiments, after selecting a storage drive where no fragments conflict with the fragment to be stored, the system checks any other fragments stored on other storage drives of the storage node to determine how many fragments from the same stripe are present on the storage node at large. Metadata for the stripe is compared to stripe identifying metadata in each fragment to determine the number of fragments stored in the storage node that are associated with the stripe.

In some examples, the predetermined threshold that defines the fragment limit (i.e., the number of fragments from a given stripe placed on the storage drives of a storage node) is calculated based on the number of parity fragments corresponding to each stripe and the maximum number of node failures to data storage system is configured to tolerate. In some other examples, the fragment limit is directly equal to the number of parity fragments corresponding to a stripe of the data object.

In some embodiments, the comparison of metadata for the stripe and stripe identifying metadata in each fragments demonstrates that the number of fragments from the same stripe stored on the storage node is below a set threshold and that the inclusion of an additional fragment would not offend the threshold. The data storage system distributes the fragment to the storage drive of the storage node for storage. In some embodiments, the data storage system instructs a fragment service of the storage node to store the fragment.

In some embodiments, the comparison demonstrates that the number of fragments from the same stripe stored on the storage node is above the set threshold. In some such embodiments, the data storage system updates metadata for the stripe to reflect that the storage node in question is at capacity with regard to storing fragments from the stripe. In some such embodiments, a further storage node is then evaluated for the placement of the fragment. The system checks any other fragments stored on the further storage node to determine how many fragments from the same stripe are present. Metadata for the stripe is compared to stripe identifying metadata held by each fragment to determine the number of fragments stored in the further storage node that are associated with the stripe. In some embodiments, the comparison demonstrates that the number of fragments from the same stripe stored on the further storage node is below the set threshold and that the inclusion of an additional fragment would not offend the threshold. The data storage system distributes the fragment to an available storage drive of the further storage node for storage. In some embodiments, the data storage system instructs a fragment service of the further storage node to store the fragment.

In some embodiments, data objects are divided into data fragments and parity fragments. In some such embodiments, the predetermined threshold that limits the number of fragments from the same stripe that a given storage node may hold is equal to the number of parity fragments present in the fragments that make up the data object.

Various embodiments of the present technology provide for a wide range of technical effects, advantages, and/or improvements to computing systems and components. For example, various embodiments may include one or more of the following technical effects, advantages, and/or improvements: 1) non-routine and unconventional implementation of efficient and durable erasure coding processes for storing data object objects; and 2) non-routine and unconventional operations for placing fragments of erasure coded data objects.

In particular, the various embodiments of the present technology allow for cost-effective deployment of wide erasure coding schemes (i.e., erasure coding spread over a large number of failure domains) using fewer distributed data storage system resources. The various embodiments further provide for techniques that limit the number of fragments from a given fragment group that can be stored on the various storage drives of a storage node. As such, erasure coding techniques can be executed on smaller distributed data storage systems having fewer resources all while preserving the ability to reconstruct data objects in spite of fragments lost to domain failure.

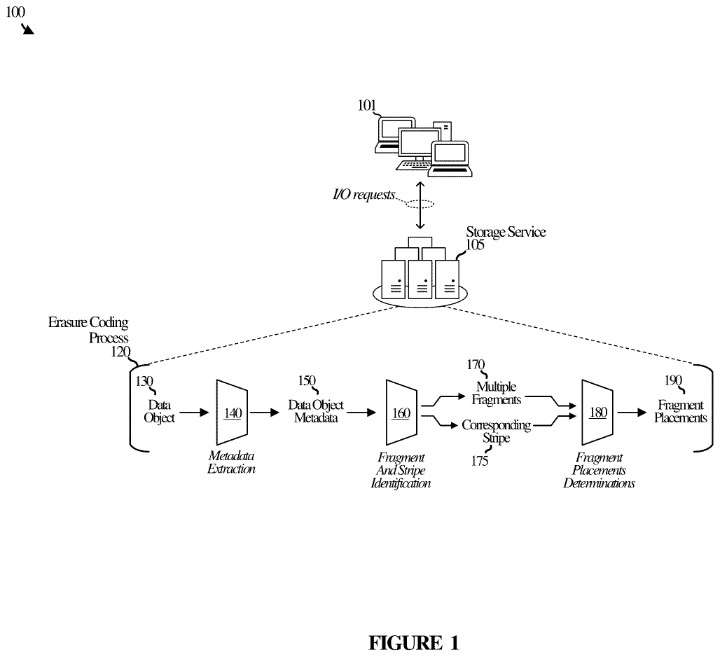

FIG. 1 illustrates operating environment 100 in accordance with an implementation. Operating environment 100 includes clients 101, storage service 105, and erasure coding process 120. Erasure coding process 120 further includes data object 130, metadata extraction 140, data object metadata 150, fragment and stripe identification 160, multiple fragments 170, corresponding stripe 175, fragment placements determinations 180, and fragment placements 190.

Operating environment 100 is representative of an operating environment in which a distributed data storage service may function and carry out data storage processes. Operating environment 100 may be, for example, a distributed computing environment, in which clients 101 communicate with storage service 105 via network communication protocols such as TCP/IP.

Clients 101 is generally representative of one or more end users or other actors that interact with storage service 105 to store and access data. Clients 101 may include a client user, a client administrator, a client application, and the like. Clients 101 store data in storage service 105 as data objects (e.g., data object 130). Clients 101 also request that storage service 105 serves the data object such that clients 101 can access or modify the data object. For example, clients 101 may include an application that generates production data and stores the production data as data objects in storage service 105.

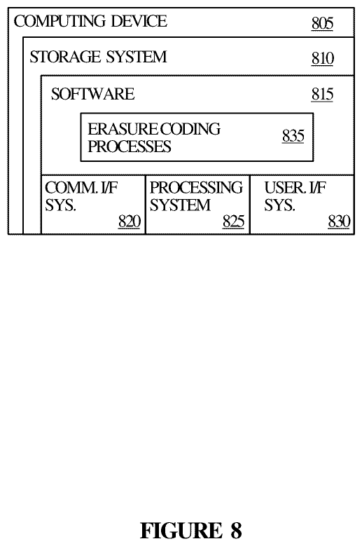

Storage service 105 is generally representative of a distributed data storage service that allows data to be stored as data objects. Storage service 105 further represents an environment in which erasure coding processes, such as erasure coding process 120, are carried out. The elements of storage service 105 may be implemented via a number of physical or virtual computing devices, an example of which is given by computing device 805 of FIG. 8. Storage service 105 is configured to store data as data objects, and also to apply erasure coding to data objects being stored or that are already stored in storage service 105. An example of a distributed storage service that storage service 105 is representative of is STORAGEGRID® by NETAPP®.

Erasure coding process 120 is representative of a process for carrying out erasure coding on a data object to be stored in storage service 105. As illustrated in FIG. 1, erasure coding process 120 is shown as being an element of storage service 105. In particular, erasure coding process 120 may be included in administration node 107, storage node 109, storage node 110, or in a combination thereof. Notably, where each of administration node 107, storage node 109, and storage node 110 respectively include erasure coding process 120, each of administration node 107, storage node 109, and storage node 110 may process a data object to be stored in storage service 105, process a data object that is already stored in storage service 105, and store fragments received from another storage node of storage service 105.

Data object 130 is representative of object data stored in, or to be stored in, storage service 105. Data object 130 may have already been erasure coded, or may require erasure coding. Where data object 130 has not yet been erasure coded, data object 130 is divided into equal size fragments, the fragments are organized into groups, and parity fragments are generated for each group. Where data object 130 has already been erasure coded, metadata extraction 140 is leveraged to identify fragments that correspond to a particular stripe. Data object 130 may correspond to user data, production data, or to any type of data clients 101 may wish to store in storage service 105. Data object 130 may exist within storage service 105 or may be submitted by clients 101 to storage service 105. Data object 130 is fed to metadata extraction 140, which isolates metadata for the data object in order to identify fragments of the data object and stripes to which those fragments correspond. Metadata extraction 140 outputs data object metadata 150, which is fed to fragment and stripe identification 160. Fragment and stripe identification 160 identifies multiple fragments 170 and corresponding stripe 175 for multiple fragments 170. Multiple fragments 170 and corresponding stripe 175 are fed to fragment placements determinations 180, which produces fragment placements 190. Fragment placements determinations 180 is representative of algorithmic processes for determining how each of multiple fragments 170 are to be distributed across storage service 105. Fragment placements 190 is the outcome of fragment placements determinations 180 and represents the selected storage drives and storage nodes of storage service 105 in which each of multiple fragments 170 will be placed.

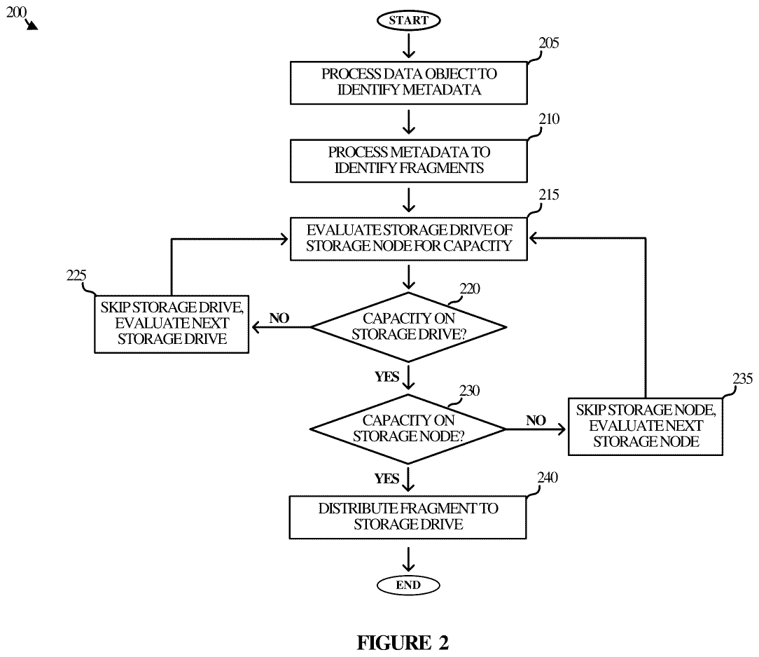

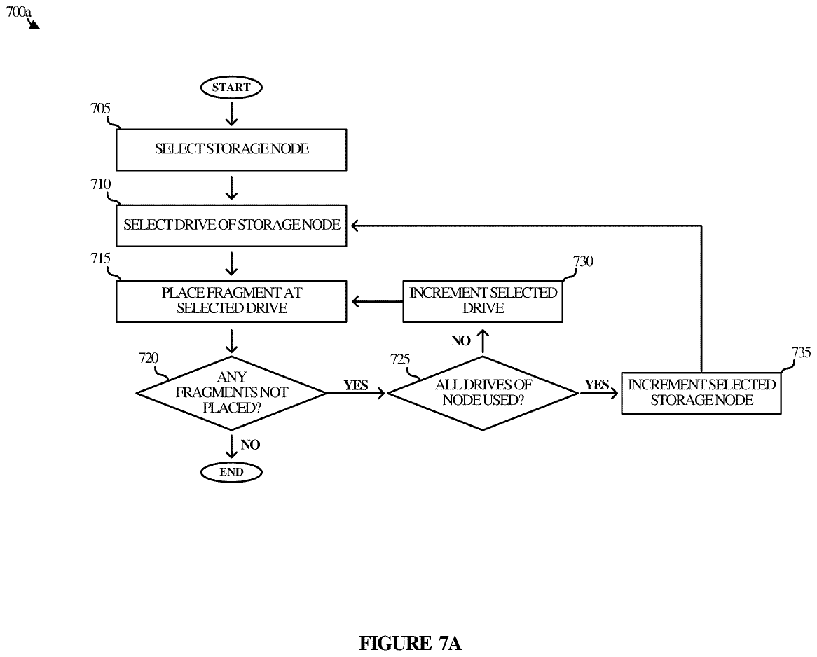

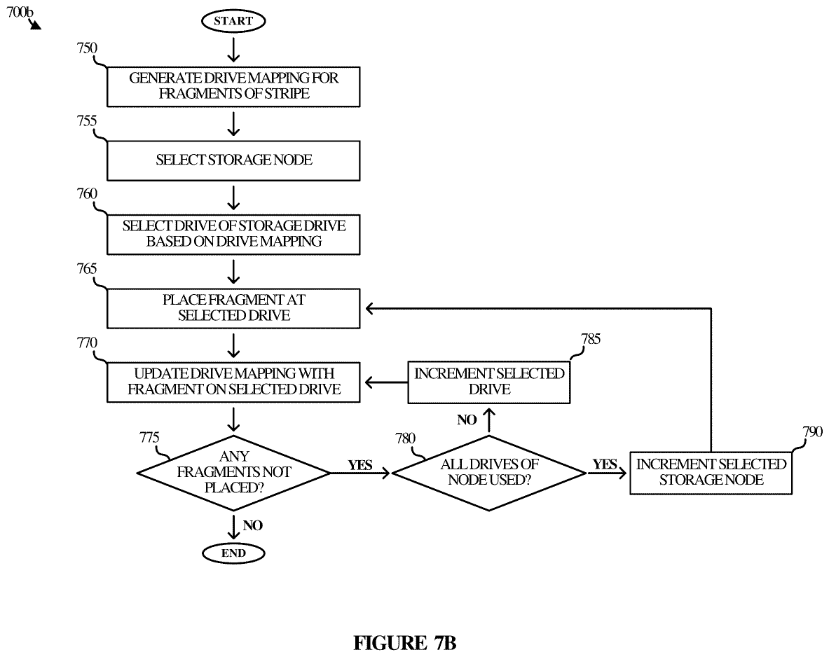

FIG. 2 illustrates method 200 in an implementation. Method 200 is representative of an erasure coding process (e.g., erasure coding process 120 of FIG. 1) and may be implemented in program instructions in the context of the software and/or firmware elements of storage service 105. The program instructions, when executed by one or more processing devices of one or more computing systems (e.g., computing device 805 in FIG. 8), direct the one or more computing systems to operate as follows, referring parenthetically to the steps in FIG. 2, and in the singular to a computing device for the sake of clarity. Other examples of an erasure coding process in other embodiments as disclosed herein are given by FIG. 7A and FIG. 7B, respectively.

To begin, a data object (e.g., data object 130 of FIG. 1) is processed to identify metadata for the data object (step 205). The metadata for the data object allows for fragments of the data object to be identified and also for the identification of the stripe the fragments correspond to. Using the metadata, fragments of the data object are identified (step 210). Each of the fragments corresponds to a single stripe, though in other examples fragments belonging to various stripes may be identified. A storage drive in a storage node is evaluated to determine if the storage drive has the capacity to store a fragment (step 220). To evaluate the availability of the storage drive, the contents of the storage drive are analyzed to determine if any fragments of the storage drive correspond to the same stripe as the fragment to be stored. Where the storage drive already holds a fragment corresponding to the stripe, the available capacity of the storage drive is insufficient to store the fragment, the storage drive is skipped, and another storage drive is evaluated (step 225). Where the storage drive does not hold a fragment corresponding to the stripe, the storage drive has sufficient available capacity, and the capacity of the storage node containing the storage drive is then evaluated at large (step 230). Where the various storage drives of the storage node collectively hold a number of fragments corresponding to the stripe that meets or exceeds a predetermined threshold, the storage node itself does not have available capacity for the fragment despite the available capacity of a storage drive within the node. As a result, the storage node is skipped and another storage node and the storage drives therein are evaluated (step 235). Where the various storage drives of the storage node collectively hold a number of fragments corresponding to the stripe that does not meet or exceed the predetermined threshold, the storage node has available capacity, and the fragment can be stored on the storage drive. In response, the fragment is transmitted to the storage drive to be stored (step 240).

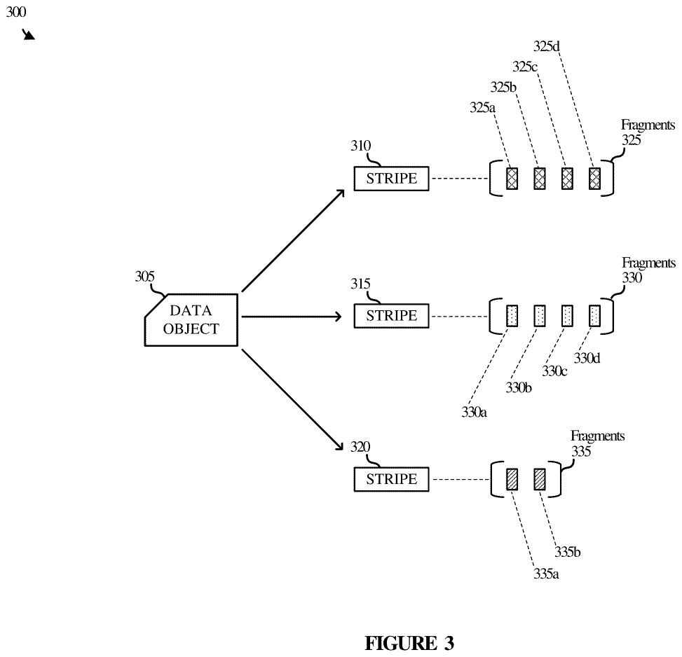

FIG. 3 illustrates operational scenario 300 in accordance with an implementation.

Operational scenario 300 includes data object 305, stripe 310, stripe 315, and stripe 320. Stripe 310 contains fragments 325, which further includes fragment 325a, fragment 325b, fragment 325c, and fragment 325d. Stripe 315 contains fragments 330, which further includes fragment 330a, fragment 330b, fragment 330c, and fragment 330d. Stripe 320 contains fragments 335, which further includes fragment 335a, and fragment 335b.

Operational scenario 300 is representative of a scenario in a storage service (e.g., storage service 105 of FIG. 1) in which a data object (e.g., data object 130 of FIG. 1) is processed. Operational scenario 300 is an example of the various processes in which a data object is processed in order to identify fragments corresponding to an erasure coding stripe. In some scenarios, the data object has already been erasure coded. In such examples, operational scenario 300 identifies the fragments and corresponding stripe for the data object based on the erasure coding performed previously. In some other scenarios, the data object has not been erasure coded. In such examples, a server of the storage service divides the data object into equally sized portions. The portions, commonly known as fragments, are organized into groups, known as stripes. The stripes may contain the same number of fragments, or in some cases, one or more stripes may contain more or fewer fragments than other stripes of the data object. For each stripe, parity fragments are generated to facilitate the ability to reconstruct the data object from fragments despite the loss of some number of fragments.

Data object 305 is representative of object data stored in, or to be stored in, a storage service, such as storage service 105 of FIG. 1. An example of such a data object is given by data object 130, also of FIG. 1.

Each of stripe 310, stripe 315, and stripe 320 are generally representative of an erasure coding stripe of data object 305. Data object 305 is processed, resulting in the identification of multiple fragments (e.g., multiple fragments 170 of FIG. 1) and a corresponding stripe (e.g., corresponding stripe 175 of FIG. 1). Based on the multiple fragments and the corresponding stripe, placement determinations for the fragments are produced. The multiple fragments are placed in storage drives of storage nodes of the storage service by a server of the storage service. In some embodiments, the server is some other computing device, such as a controller. An example of such a computing device is given by computing device 805 of FIG. 8. The server compares the corresponding stripe for the multiple fragments and a stripe associated with any fragment already stored in a particular storage drive of a storage node. Where the storage drive already contains a fragment from the corresponding stripe, the storage drive is skipped (i.e., the storage drive is not used for placing the fragment) and another storage drive is evaluated for the placement of the fragment. In some cases, the storage node containing the storage drive is at a capacity with regard to fragments from the corresponding stripe. In such scenarios, all of the storage drives in the storage node at capacity are skipped, and another storage node is evaluated for placement of the fragments.

In one example, data object 305 is processed to identify stripe 310, stripe 315, and stripe 320. Fragments corresponding to each erasure coding stripe are identified. In some embodiments, fragments corresponding to each of the erasure coding stripes of data object 305 are identified, while in other embodiments, the fragments of a single erasure coding stripe are identified. As illustrated here, data object 305 is processed and stripe 310, stripe 315, and stripe 320 are identified. Fragments 325, fragments 330, and fragments 335 are identified for each of stripe 310, stripe 315, and stripe 320, respectively.

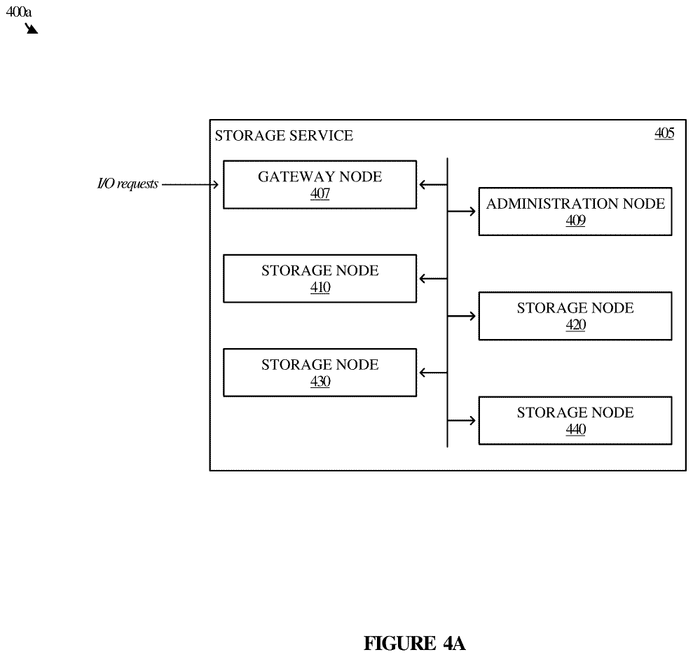

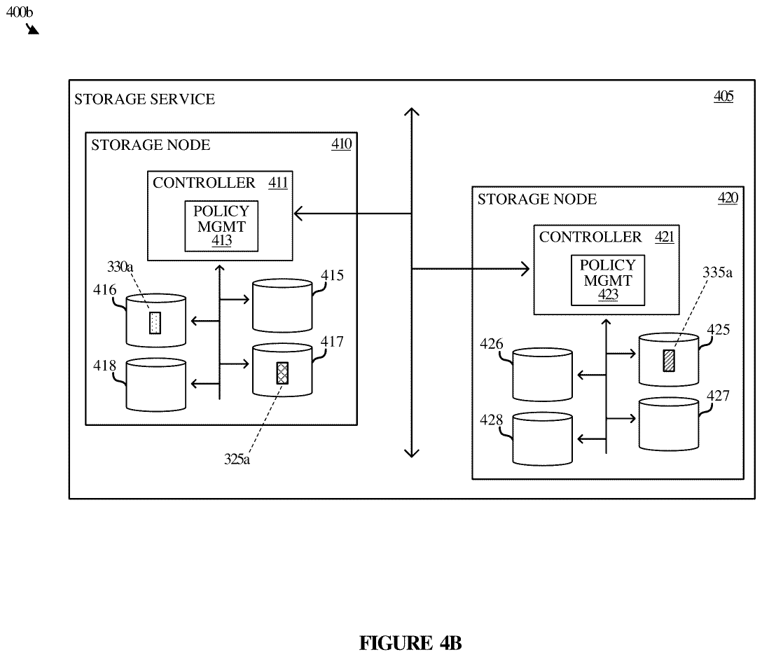

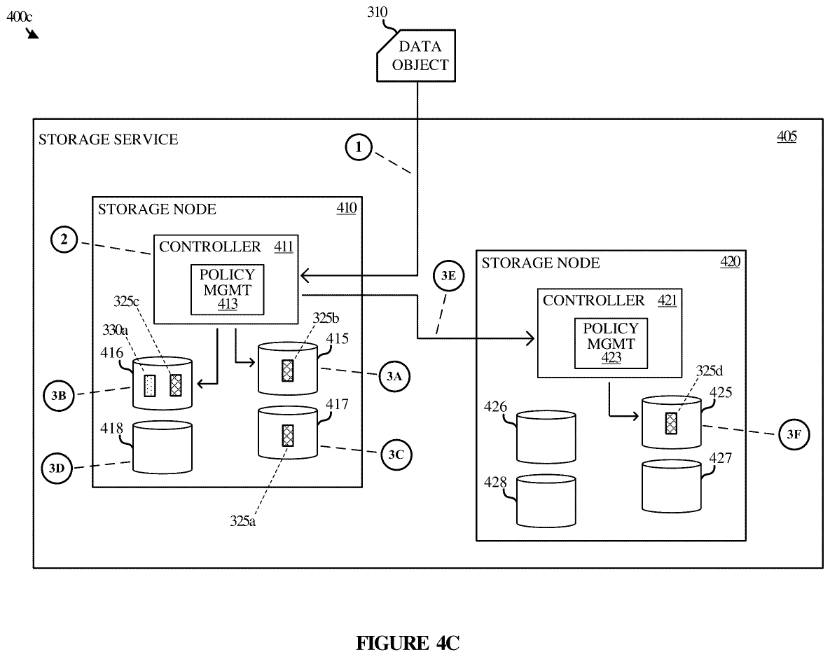

FIG. 4A illustrates detailed storage service 400a in accordance with an embodiment. Detailed storage service 400 includes storage service 405. As illustrated in FIG. 4, storage service 405 includes gateway node 407, administration node 409, storage node 410, storage node 420, storage node 430, and storage node 440.

Storage service 405 is generally representative of a distributed data storage service that allows data to be stored as data objects, an example of which is given by storage service 105 of FIG. 1. In other embodiments, storage service 405 may contain more or fewer constituent components. For example, in some embodiments, storage service 405 may include many thousands, or even many tens of thousands, of storage nodes.

Gateway node 401 is generally representative of a gateway node in an object storage service that acts as an interface between clients and the underlying storage system. Gateway node 401 is generally responsible for translating requests into operations understood by the storage nodes. This enables efficient data access, load balancing, and security enforcement, while abstracting the complexity of the distributed storage architecture from the end user. In some embodiments, storage service 405 does not include gateway node 401.

Administration node 409 is generally representative of an administrator node that may be implemented in hardware, software, or firmware. Administration node 409 manages the overall operations of storage service 405, including configuration, monitoring, and orchestration of storage and gateway nodes. Administration node 409 facilitates tasks such as system health checks, capacity management, and policy enforcement, ensuring the efficient functioning and scalability of the storage service. Some of the processes that administration node 409 orchestrates for storage service 405 include load balancing, data ingestion, and the distribution of storage policies and storage policy updates to various elements of storage service 405.

Storage node 410, storage node 420, storage node 430, and storage node 440 are each generally representative of a storage node of storage service 405 that includes one or more storage drives sufficient for the storing of fragments of data objects (e.g., fragments 325 of FIG. 3). Each of storage node 410, storage node 420, storage node 430, and storage node 440 are configured to receive and store fragments of data objects. In some embodiments, storage node 410, storage node 420, storage node 430, and storage node 440 are each configured to receive data object from clients, such as clients 101 of FIG. 1, and to perform erasure coding processes, such as erasure coding process 120, on the data object. In some cases, storage node 410, storage node 420, storage node 430, and storage node 440 are each configured to evaluate storage drives contained therein, respectively, as well as storage drives of other storage nodes of storage service 405 in order to carry out erasure coding process 120.

In some cases, each of storage node 410, storage node 420, storage node 430, and storage node 440 are configured to determine that a given storage node of storage service 405 is at capacity with respect to storing fragments that correspond to a particular stripe. In such a case, the storage node at capacity is skipped with respect to storing the fragment, and another storage node can be evaluated. For example, where storage node 410 receives a data object, the data object is processed such that fragments, and the stripes the fragments correspond to, can be identified. In such an example, where storage node 410 is unable to store a fragment of the data object, storage node 410 transmits the fragment to storage node 420 for evaluation and storage. In some cases, storage node 420 may evaluate the fragment and storage drives of storage node 420 in order to store the fragment without having received the fragment from storage node 109. In such a case, where storage node 420 determines the fragment can be stored therein, storage node 410 transmits the fragment to storage node 420.

FIG. 4B illustrates detailed storage nodes 400b in accordance with an implementation. Detailed storage nodes 400b includes storage node 410 and storage node 420, each of storage service 405 of FIG. 4A, respectively. Each of storage node 410 and storage node 420 are described in further detail in the associated text to FIG. 4A. As illustrated in FIG. 4B, storage node 410 further includes controller 411, storage drive 415, storage drive 416, storage drive 417, and storage drive 418. Controller 411 further includes policy management 413. As illustrated in FIG. 4B, storage node 420 further includes controller 421, storage drive 425, storage drive 426, storage drive 427, and storage drive 428. Controller 421 further includes policy management 423.

Each of controller 411 and controller 421 are generally representative of a computing device sufficient to implement erasure coding processes, such as erasure coding process 120 of FIG. 1. Controller 411 and controller 421 are configured to manage data flow between various storage drives of storage service 405 and the network connecting the elements of storage service 405 and end users (e.g., clients 101). In particular, each of controller 411 and controller 421 are configured to determine how to distribute fragments of an erasure coded object to drive-level failure domains by evaluating failure domains for conflicts. Each of controller 411 and controller 421 are further configured to limit the number of fragments from a given stripe that are placed on any storage node in order to minimize fragment loss due to failure of an entire storage node. An example of such a computing device is provided by computing device 805 of FIG. 8. Each of controller 411 and controller 421 may be implemented in hardware, software, or firmware, and may be implemented via virtual computing resources.

Policy management 413 and policy management 423 are each representative of, which may be hardware, software, or firmware configured to maintain erasure coding rules, policies, and schemes that support erasure coding process 120. Policy management 413 and policy management 423 are generally configured to enforce data handling rules, such as replication, retention, and tiering, based on predefined storage policies. Controller 411 and controller 421 may dynamically adjust data placement, access permissions, and redundancy levels of policy management 413 and policy management 423 respectively, optimizing resource usage and ensuring compliance with system-wide data governance requirements. In a scenario where storage node 410 or storage node 420 receives a fragment from another storage node, such as storage node 110 of FIG. 1, policy management 413 and policy management 423 can be leveraged to inform processing of and placement of the fragment.

Each of storage drive 415, storage drive 416, storage drive 417, storage drive 418, storage drive 425, storage drive 426, storage drive 427, and storage drive 428 are generally representative of storage media sufficient for storing fragments of data objects and may each be a storage drive, a storage disk, or some other storage media. Each of storage drive 415, storage drive 416, storage drive 417, storage drive 418, storage drive 425, storage drive 426, storage drive 427, and storage drive 428 are configured to receive and store fragments of a data object, and to provide the fragments stored therein upon request. In particular, each of storage drive 415, storage drive 416, storage drive 417, storage drive 418, storage drive 425, storage drive 426, storage drive 427, and storage drive 428 are directed to store only one fragment from any given stripe to minimize the effects of an entire storage node failing. As a result, the ability of the storage service (e.g., storage service 405 of FIG. 4A) to reconstruct the data object from its constituent fragments.

FIG. 4C illustrates operational scenario 400c in accordance with an implementation. Operational scenario 400c includes storage node 410 and storage node 420. Storage node 410 includes controller 411, storage drive 415, storage drive 416, storage drive 417, and storage drive 418. Controller 411 further includes policy management 413. Storage node 420 includes controller 421, storage drive 425, storage drive 426, storage drive 427, and storage drive 428. Controller 421 further includes policy management 423.

Storage node 410 and storage node 420 are each respectively representative of a storage node of a distributed data storage system, such as storage service 105, that includes one or more storage drives sufficient for the storing of fragments of data objects. Examples of such storage nodes are given by storage node 109 and storage node 110, both of FIG. 1.

Controller 411 and controller 421 are each respectively representative of a computing device sufficient to implement erasure coding processes, such as erasure coding process 120 of FIG. 1, an example of which is given by controller 211 of FIG. 2. Controller 411 and controller 421 may be implemented on computing device 805 of FIG. 8.

Policy management 413 and policy management 423 are each respectively representative of logic for directing the performance and functionality of various data storage processes. In particular, policy management 413 and policy management 423 each comprise logic that governs erasure coding processes, such as erasure coding process 120 of FIG. 1.

Each of storage drive 415, storage drive 416, storage drive 417, storage drive 418, storage drive 425, storage drive 426, storage drive 427, and storage drive 428 are generally representative of storage media sufficient for storing fragments of data objects and may be a storage drive, a storage disk, or some other storage media. An example of such storage drives is provided by each of storage drive 215, storage drive 216, storage drive 217, and storage drive 218, each of FIG. 1, respectively.

Operational scenario 400c illustrates a portion of an erasure coding process in which a data object is received, the data object is processed, and fragments making up the data object are each distributed. First, storage node 410 receives the data object. Storage node 410 may have received the data object from clients, such as clients 101 of FIG. 1, from another element of the data storage system, or even from within the storage drives included in storage node 410. During the second portion of the process, controller 411 of storage node 410 receives data object 310, processes data object 310, and generates fragment placements for a number of fragments making up data object 310. Controller 411 queries policy management 413 for instructions on how the data object is to be handled. In some scenarios, policy management 413 supplies an erasure coding strategy, sometimes called an erasure coding scheme, to controller 411. Based on processing the data object, controller 411 identifies fragments of the data object that correspond to a particular stripe (group of fragments). Controller 411 first selects a storage node to evaluate with regard to storing the fragments of the stripe. Here, controller 411 first selects storage node 410, but may have otherwise first selected storage node 420.

Having selected storage node 410, controller 411 then selects storage drive 415 to evaluate with regard to storing a single fragment of the stripe. Controller 411 may have otherwise selected another storage drive to begin with in other examples. Controller 411 evaluates stripe metadata for the stripe and a stripe identification for any fragment stored in storage drive 415 to determine if a stripe conflict is present. A stripe conflict indicates that the fragment to be placed belongs to the same stripe as an existing fragment stored in storage drive 415. Based on the restriction that limits each failure domain to a single fragment of the data object, a stripe conflict results in the skipping of a given storage drive with respect to storing the fragment. Here, no stripe conflict exists between the stripe and any fragment already stored in storage drive 415. Controller 411 then checks storage node 410 at large to determine if storage node 410 is at capacity with regard to fragments from the stripe (i.e., fragments 325). Where the storage drives of storage node 410 collectively contain a number of fragments that meet or exceeds a predetermined threshold, storage node 410 at large lacks the capacity to store the fragment. In response, storage node 410 is skipped with regard to storing the fragment. Here, the storage drives of storage node 410 collectively contain a number of fragments that do not meet or exceed a predetermined threshold. As a result, storage drive 415 is selected as the fragment placement for fragment 325b.

Similarly, storage drive 416 is evaluated with respect to storing fragment 325c of the stripe. As a result of the evaluation, storage drive 416 is selected as the fragment placement for the fragment 325c.

Controller 411 then evaluates storage drive 417 with regard to storing the next fragment of the stripe. Based on the evaluation, controller 411 determines that storage drive 417 already holds one of fragments 325 (in this case, fragment 325a), and therefore a stripe conflict occurs. As a result, storage drive 417 is skipped with regard to storing a fragment of the stripe.

Controller 411 then evaluates storage drive 418 with regard to storing the remaining fragment of the stripe. Based on the evaluation, controller 411 determines that storage drive 417 does not already hold one of fragments 325 from the same stripe, therefore no stripe conflict exists. Controller 411 then rechecks storage node 410 at large to determine if storage node 410 is now at capacity with regard to fragments from the stripe. Here, each of storage drive 415, storage drive 416, and storage drive 417 already contain a fragment from the stripe (i.e., fragments 325). In this scenario, each of storage node 410 and storage node 420 may only hold a total of three fragments from the stripe. As a result, storage node 410 is at capacity with regard to storing fragments from the stripe and is skipped.

Controller 411, in response to skipping storage node 410, evaluates storage node 420. Controller 411 determines that no fragment already stored in storage drive 425 corresponds to the stripe, and therefore no stripe conflict exists. Controller 411 then checks storage node 420 at large to determine if storage node 420 is at capacity with regard to fragments from the stripe. Here, the storage drives of storage node 420 collectively contain a number of fragments that do not meet or exceed the predetermined threshold. As a result, storage drive 425 is selected for the placement of fragment 325c.

During the third portion of the process, the various fragments are distributed in accordance with the fragment placements. With the fragment placements determined for each of the fragments to be placed, each fragment is respectively distributed based on the fragment placements. Each respective fragment is then stored by the recipient element of storage service 405.

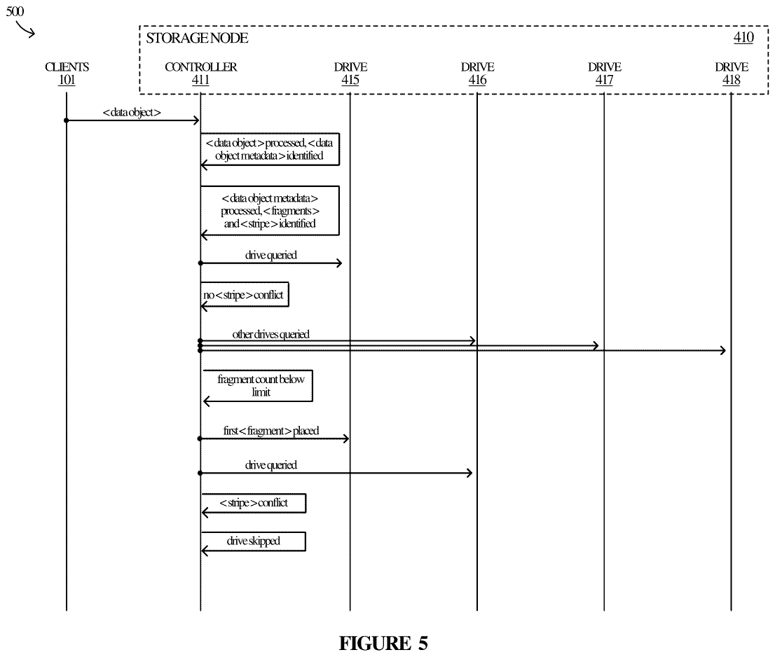

FIG. 5 illustrates operational sequence 500 in accordance with an implementation. Operational sequence 500 includes clients 101 of FIG. 1 and storage node 410 of FIG. 4, which further includes controller 411, storage drive 415, storage drive 416, storage drive 417, and storage drive 418.

Operational sequence 500 begins with storage node 410 receiving the data object. Storage node 410 receives the data object from clients 101. Controller 411 of storage node 410 receives and processes the data object. In some cases, controller 411 queries a policy management, such as policy management 413, for instructions on how the data object is to be handled. Based on processing the data object, controller 411 identifies fragments of the data object that correspond to a particular stripe (group of fragments). Controller 411 first selects a storage node to evaluate with regard to storing the fragments of the stripe.

Having selected storage node 410, controller 411 then selects storage drive 415 to evaluate with regard to storing a single fragment of the stripe. Controller 411 may have otherwise selected another storage drive, such as storage drive 416, to begin with. Controller 411 evaluates stripe metadata for the stripe and a stripe identification for any fragment stored in storage drive 415 to determine if a stripe conflict is present. A stripe conflict indicates that the fragment to be placed belongs to the same stripe as an existing fragment stored in storage drive 415. Based on the restriction that limits each failure domain to a single fragment of the data object, a stripe conflict results in the skipping of a given storage drive with respect to storing the fragment. Here, no stripe conflict exists between the stripe and any fragment already stored in storage drive 415. Controller 411 then checks storage node 410 at large to determine if storage node 410 is at capacity with regard to fragments from the stripe. Where the storage drives (i.e., storage drive 415, storage drive 416, storage drive 417, and storage drive 418) of storage node 410 collectively contain a number of fragments that meets or exceeds a predetermined threshold, storage node 410 at large lacks the capacity to store the fragment. Here, the storage drives of storage node 410 collectively contain a number of fragments that do not meet or exceed a predetermined threshold. As a result, the fragment is stored in storage drive 415.

Storage drive 416 is then evaluated with respect to storing the next fragment of the stripe. Controller 411 evaluates stripe metadata for the stripe and a stripe identification for any fragment stored in storage drive 416 to determine if a stripe conflict is present. Here, controller 411 determines that a fragment stored in storage drive 416 corresponds to the stripe, and therefore a stripe conflict is present. As a result of the evaluation, storage drive 416 is skipped with regard to storing the next fragment.

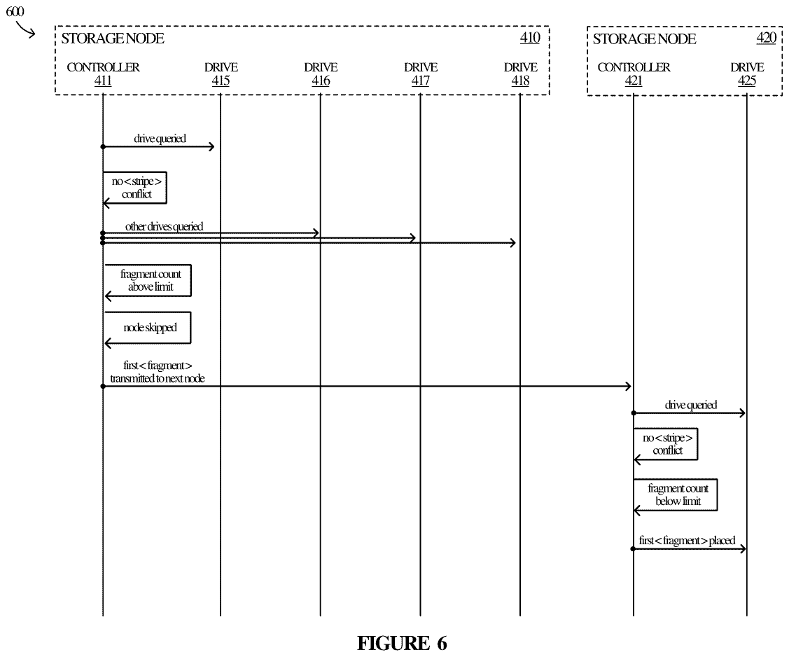

FIG. 6 illustrates another operational sequence 600 in accordance with an implementation. Controller 411 evaluates storage drive 415 with regard to storing a fragment of the stripe. Based on the evaluation, controller 411 determines that storage drive 415 does not already hold a fragment from the same stripe, therefore no stripe conflict exists. Controller 411 then checks storage node 410 at large to determine if storage node 410 is now at capacity with regard to fragments from the stripe. To check storage node 410 at large, each of the storage drives contained therein are evaluated. Here, controller 411 determines that each of storage drive 416, storage drive 416, and storage drive 418 already contain a fragment from the stripe. In this scenario, each of storage node 410 and storage node 420 may only hold a total of three fragments from the stripe. As a result, storage node 410 is at capacity with regard to storing fragments from the stripe and is skipped.

Controller 411, in response to skipping storage node 410, transmits the fragment to storage node 420, where the fragment is received by controller 421. Controller 421 receives the fragment, and in some cases, queries a policy management (policy management 423 of FIG. 4) for instructions on how the fragment is to be stored. In some cases, controller 421 does not query policy management 423, but instead receives instruction information from controller 411, which queried policy management 413 of FIG. 4 for instructions. In either case, controller 421 evaluates storage drive 425 with regard to storing the remaining fragment of the stripe. Controller 421 determines that no fragment already stored in storage drive 425 corresponds to the stripe, and therefore no stripe conflict exists. Controller 421 then checks storage node 420 at large to determine if storage node 420 is at capacity with regard to fragments from the stripe. Here, the storage drives of storage node 420 collectively contain a number of fragments that do not meet or exceed the predetermined threshold. As a result, the fragment is stored in storage drive 425.

FIG. 7A illustrates determine fragment placements 700a in an implementation. Determine fragment placements 700a is representative of a process for determining fragment placements and may be implemented in program instructions in the context of the software and/or firmware elements of storage service 105. The program instructions, when executed by one or more processing devices of one or more computing systems (e.g., computing device 805 in FIG. 8), direct the one or more computing systems to operate as follows, referring parenthetically to the steps in FIG. 7A, and in the singular to a computing device for the sake of clarity.

To begin, a storage node (e.g., storage node 410 of FIG. 4) of a data storage system (e.g., storage service 105 of FIG. 1) is selected for evaluation of the storage drives therein for the purpose of storing fragments of a data object (step 705). A storage drive of the storage node is then selected (step 710). The selected storage drive and used as the fragment placement for storing a fragment of the data object (step 715). The selection of the storage node, and subsequently the selection of the storage drive from within the storage node, may be arbitrary in determine fragment placements 700a.

In some cases, various layers of the storage service or the host environment of the storage service dictate which storage node and storage drive should be selected first. An example of such a procedure load balancing performed at an administrative node, such as administrative node 409 of FIG. 4. However, with regard to determine fragment placements 700a, because the first selection of the storage node and the storage drive correspond to the first fragment being placed, evaluating the storage node and storage drives therein for the purposes of avoiding conflicts between fragments of the same erasure coding stripe is unnecessary. After the placement of the first fragment, the avoidance of conflicts between fragments of the same erasure coding stripe becomes applicable.

With the fragment placement determined, the storage service evaluates if there are remaining fragments for which fragment placements are still needed (step 720). Where no fragments remain in need of a fragment placement, the method concludes. Where one or more fragments still require a fragment placement, the storage node is first evaluated (step 725). Where one or more storage drives of the storage node remain available (i.e., do not yet hold a fragment corresponding to the erasure coding stripe), another storage drive of the initially selected storage node is selected (step 730). Where all of the storage drives of the storage node have been used for storing a fragment, the storage service increments to another storage node to evaluate for fragment placement (735).

FIG. 7B illustrates determine fragment placements 700b in an implementation. Determine fragment placements 700b is representative of a process for determining fragment placements and may be implemented in program instructions in the context of the software and/or firmware elements of storage service 105. The program instructions, when executed by one or more processing devices of one or more computing systems (e.g., computing device 805 in FIG. 8), direct the one or more computing systems to operate as follows, referring parenthetically to the steps in FIG. 7B, and in the singular to a computing device for the sake of clarity.

To begin, a data storage system (e.g., storage service 105 of FIG. 1) generates a fragment mapping for fragments of a data object that correspond to an erasure coding stripe (step 750). The fragment mapping contains indications of which storage drives of which storages nodes any fragments have been placed in. Based on the fragment mapping, subsequent selections of storage nodes and storage drives therein can be made with an improved ability to avoid storing more than one fragment from the erasure coding stripe on any given storage drive. A storage node (e.g., storage node 410 of FIG. 4) of is selected for evaluation of the storage drives therein for the purpose of storing fragments of a data object (step 755). A storage drive of the storage node is then selected based on the fragment mapping (step 760). The selected storage drive and used as the fragment placement for storing a fragment of the data object (step 765). The selection of the storage node, and subsequently the selection of the storage drive from within the storage node, may be arbitrary in determine fragment placements 700b.

In some cases, various layers of the storage service or the host environment of the storage service dictate which storage node and storage drive should be selected first. An example of such a procedure load balancing performed at an administrative node, such as administrative node 409 of FIG. 4. However, with regard to determine fragment placements 700b, because the first selection of the storage node and the storage drive correspond to the first fragment being placed, evaluating the storage node and storage drives therein for the purposes of avoiding conflicts between fragments of the same erasure coding stripe is unnecessary. After the placement of the first fragment, the use of the fragment mapping to avoid conflicts between fragments of the same erasure coding stripe becomes beneficial.

With the fragment placement determined, the storage service updates the fragment mapping to reflect the determined fragment placement. The fragment mapping is revised to include metadata for the placed fragment, such as a corresponding stripe, a storage drive location, and the like. The information contained in the periodically updated fragment mapping allows the storage system to track how many fragments have been placed and where, based on which, subsequent fragment placements can be determined. In some embodiments, the fragment mapping is used to determine a fragment count. The fragment count is a number of fragments stored on a given storage node that correspond to a particular erasure coding stripe.

The storage service evaluates if there are remaining fragments for which fragment placements are still needed (step 775). Where no fragments remain in need of a fragment placement, the method concludes. Where one or more fragments still require a fragment placement, the storage node is first evaluated (step 780). Where one or more storage drives of the storage node remain available (i.e., do not yet hold a fragment corresponding to the erasure coding stripe), another storage drive of the initially selected storage node is selected (step 785). Where all of the storage drives of the storage node have been used for storing a fragment, the storage service increments to another storage node to evaluate for fragment placement (790).

FIG. 8 illustrates computing device 805, which is representative of any system or collection of systems in which the various applications, processes, services, and scenarios disclosed herein may be implemented. Examples of computing apparatus illustrated by computing device 805 include, but are not limited to server computers, web servers, cloud computing platforms, and data center equipment, as well as any other type of physical or virtual server machine, container, and any variation or combination thereof. (In some examples, computing device 805 may also be representative of desktop and laptop computers, tablet computers, and the like.)

Computing device 805 may be implemented as a single apparatus, system, or device or may be implemented in a distributed manner as multiple apparatuses, systems, or devices. Computing device 805 includes, but is not limited to, processing system 825, storage system 810, software 815, communication interface system 820, and user interface system 830. Processing system 825 is operatively coupled with storage system 810, communication interface system 820, and user interface system 830.

Processing system 825 loads and executes software 815 from storage system 810. Software 815 includes and implements erasure coding processes 835, which is representative of the processes discussed with respect to the preceding Figures. When executed by processing system 825, software 815 directs processing system 825 to operate as described herein for at least the various processes, operational scenarios, and sequences discussed in the foregoing implementations. Computing device 805 may optionally include additional devices, features, or functionality not discussed for purposes of brevity.

Referring still to FIG. 8, processing system 825 may include a micro-processor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, microcontroller units, graphical processing units, application specific processors, integrated circuits, application specific integrated circuits, and logic devices, as well as any other type of processing device, combinations, or variations thereof.

Storage system 810 may comprise any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 810 may be implemented as a single storage device but may also be implemented across multiple storage devices or sub-systems co-located or distributed relative to each other. Storage system 810 may comprise additional elements, such as a controller, capable of communicating with processing system 825 or possibly other systems.

Software 815 (including erasure coding processes 835) may be implemented in program instructions and among other functions may, when executed by processing system 825, direct processing system 825 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 815 may include additional processes, programs, or components, such as operating system software, virtualization software, or other application software. Software 815 may also comprise firmware or some other form of machine-readable processing instructions executable by processing system 825.

In general, software 815, when loaded into processing system 825 and executed, transforms a suitable apparatus, system, or device (of which computing device 805 is representative) overall from a general-purpose computing system into a special-purpose computing system customized to support erasure coding processes as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method, comprising:
receiving a data object to be stored in a data storage system;
processing the data object to identify object metadata of the data object;
processing the object metadata to identify multiple fragments of the data object and a corresponding erasure coding stripe for the multiple fragments;
determining fragment placements for the multiple fragments to govern placing the multiple fragments in multiple storage nodes of the data storage system, wherein:
the multiple storage nodes of the data storage system comprise multiple storage drives, and
the fragment placements govern distribution of the multiple fragments such that:
for any given erasure coding stripe, no more than one fragment of the given erasure coding stripe is placed in any one of the multiple storage drives; and
two or more of the multiple fragments are placed in at least one of the multiple storage nodes; and
transmitting, based on the fragment placements, each of the multiple fragments to the multiple storage drives to place each of the multiple fragments and store the data object in the data storage system.

2. The method of claim 1, wherein determining the fragment placements further comprises:
identifying a first storage drive of a first storage node of the multiple storage nodes to evaluate for placing a first fragment of the multiple fragments;
determining, for the first storage node, a fragment count comprising a number of the multiple fragments that have been or will be placed in the first storage node;
comparing, for the first storage node, the fragment count, and a fragment limit to determine that the fragment count is below the fragment limit; and
responsively determining to use the first storage drive for placing the first fragment.

3. The method of claim 2, wherein determining the fragment placements further comprises:
identifying a further storage drive of the first storage node to evaluate for placing a further fragment of the multiple fragments;
determining, for the first storage node, an updated fragment count comprising an updated number of the multiple fragments that have been or will be placed in the first storage node;
comparing, for the first storage node, the updated fragment count, and the fragment limit to determine that the updated fragment count meets or exceeds the fragment limit; and
responsively determining to skip the further storage drive for placing the further fragment.

4. The method of claim 1, the method further comprising:
identifying a further storage node of the multiple storage nodes to evaluate for placing a first fragment of the multiple fragments;
determining, for the further storage node, a fragment count comprising a number of the multiple fragments that have been or will be placed in the further storage node;
identifying, based on the fragment count and a fragment limit, a subset of the multiple fragments to be placed in the further storage node; and
transmitting any of the multiple fragments not included in the subset to another storage node of the data storage system.

5. The method of claim 3, wherein identifying the further storage drive comprises:
incrementing from the first storage drive to the next storage drive; and
selecting, based on the incrementing, the further storage drive to identify the further storage drive.

6. The method of claim 5, wherein the fragment count is equivalent to a number of incrementations associated with the fragment placements.

7. The method of claim 3, wherein identifying the further storage drive comprises:
generating a mapping for the multiple fragments, wherein the mapping comprises indications of which of the multiple storage drives any of the multiple fragments have been or will be placed in;
updating the mapping to reflect the determining to place the first fragment in the first storage drive; and
selecting, based on the mapping, the further storage drive to identify the further storage drive.

8. The method of claim 7, wherein determining the fragment count comprises:
evaluating the mapping to determine which of the multiple storage drives any of the multiple fragments have been or will be placed in.

9. A computing device, comprising:
one or more computer readable storage media;
one or more processors operatively coupled with the one or more computer readable storage media; and
a data storage system comprising program instructions stored on the one or more computer readable storage media, wherein the program instructions, when executed by the one or more processors, direct the computing device to at least:
receive a data object to be stored in the data storage system,
process the data object to identify object metadata of the data object,
process the object metadata to identify multiple fragments of the data object and a corresponding erasure coding stripe for the multiple fragments,
determine fragment placements for the multiple fragments to govern placing the multiple fragments in multiple storage nodes of the data storage system, wherein:
the multiple storage nodes of the data storage system comprise multiple storage drives; and
the fragment placements govern distribution of the multiple fragments such that:
no one of the multiple storage drives holds two or more fragments of any given erasure coding stripe, and
two or more of the multiple fragments are placed in at least one of the multiple storage nodes; and
transmit, based on the fragment placements, each of the multiple fragments to the multiple storage drives to place each of the multiple fragments and store the data object in the data storage system.

10. The computing device of claim 9, wherein the program instructions directing the computing device to determine the fragment placements further comprise instructions that, when executed, direct the computing device to:
identify a first storage drive of a first storage node of the multiple storage nodes to evaluate for placing a first fragment of the multiple fragments;
determine, for the first storage node, a fragment count comprising a number of the multiple fragments that have been or will be placed in the first storage node;
compare, for the first storage node, the fragment count, and a fragment limit to determine that the fragment count is below the fragment limit; and
responsively determine to use the first storage drive for placing the first fragment.

11. The computing device of claim 10, wherein the program instructions directing the computing device to determine the fragment placements further comprise instructions that, when executed, direct the computing device to:
identify a further storage drive of the first storage node to evaluate for placing a further fragment of the multiple fragments;
determine, for the first storage node, an updated fragment count comprising an updated number of the multiple fragments that have been or will be placed in the first storage node;
compare, for the first storage node, the updated fragment count, and the fragment limit to determine that the updated fragment count meets or exceeds the fragment limit; and
responsively determine to skip the further storage drive for placing the further fragment.

12. The computing device of claim 9, wherein the program instructions further comprise instructions that, when executed, direct the computing device to:
identify a further storage node of the multiple storage nodes to evaluate for placing a first fragment of the multiple fragments;
determine, for the further storage node, a fragment count comprising a number of the multiple fragments that have been or will be placed in the further storage node;
identify, based on the fragment count and a fragment limit, a subset of the multiple fragments to be placed in the further storage node; and
transmit any of the multiple fragments not included in the subset to another storage node of the data storage system.

13. The computing device of claim 11, wherein the program instructions directing the computing device to identify the further storage drive further comprise instructions that, when executed, direct the computing device to:
increment from the first storage drive to the next storage drive; and
select, based on the incrementing, the further storage drive to identify the next storage drive.

14. The computing device of claim 13, wherein the fragment count is equivalent to a number of incrementations associated with the fragment placements.

15. The computing device of claim 11, wherein the program instructions directing the computing device to identify the next storage drive further comprise instructions that, when executed, direct the computing device to:
generate a mapping for the multiple fragments, wherein the mapping comprises indications of which of the multiple storage drives any of the multiple fragments have been or will be placed in;
update the mapping to reflect the determining to place the first fragment in the first storage drive; and
select, based on the mapping, the next storage drive to identify the next storage drive.

16. The computing device of claim 15, wherein the program instructions directing the computing device to determine the fragment count further comprise instructions that, when executed, direct the computing device to:
evaluate the mapping to determine which of the multiple storage drives any of the multiple fragments have been or will be placed in.

17. One or more computer readable storage media having program instructions stored thereon that, when executed by one or more processors in a computing device, direct the computing device to at least:
receive a data object to be stored in a data storage system;
process the data object to identify object metadata of the data object;
process the object metadata to identify multiple fragments of the data object and a corresponding erasure coding stripe for the multiple fragments;
determine fragment placements for the multiple fragments to govern placing the multiple fragments in multiple storage nodes of the data storage system, wherein:
the multiple storage nodes of the data storage system comprise multiple storage drives, and
the fragment placements govern distribution of the multiple fragments such that:
for any given erasure coding stripe, no more than one fragment of the given erasure coding stripe is stored in any one of the multiple storage drives; and
two or more of the multiple fragments are placed in at least one of the multiple storage nodes; and
transmit, based on the fragment placements, each of the multiple fragments to the multiple storage drives to place each of the multiple fragments and store the data object in the data storage system.

18. The one or more computer readable storage media of claim 17, wherein the program instructions further direct the computing device to:
identify a first storage drive of a first storage node of the multiple storage nodes to evaluate for placing a first fragment of the multiple fragments;
determine, for the first storage node, a fragment count comprising a number of the multiple fragments that have been or will be placed in the first storage node;
compare, for the first storage node, the fragment count, and a fragment limit to determine that the fragment count is below the fragment limit; and
responsively determine to use the first storage drive for placing the first fragment.

19. The one or more computer readable storage media of claim 18, wherein the program instructions further direct the computing device to:
identify a further storage drive of the first storage node to evaluate for placing a further fragment of the multiple fragments;
determine, for the first storage node, an updated fragment count comprising an updated number of the multiple fragments that have been or will be placed in the first storage node;
compare, for the first storage node, the updated fragment count, and the fragment limit to determine that the updated fragment count meets or exceeds the fragment limit; and
responsively determine to skip the further storage drive for placing the further fragment.

20. The one or more computer readable storage media of claim 17, wherein the program instructions further direct the computing device to:
identify a further storage node of the multiple storage nodes to evaluate for placing a first fragment of the multiple fragments;
determine, for the further storage node, a fragment count comprising a number of the multiple fragments that have been or will be placed in the further storage node;
identify, based on the fragment count and a fragment limit, a subset of the multiple fragments to be placed in the further storage node; and
transmit any of the multiple fragments not included in the subset to another storage node of the data storage system.
